(19) United States
(12) Patent Application Publication
(10) Pub. No.: US 2020/0316656 A1
(43) Pub. Date: Oct. 8, 2020

(54) AIR JET SUBSTRATE CLEANING APPARATUS

(71) Applicant: ASM Technology Singapore Pte Ltd, Singapore (SG)

(72) Inventors: Ka Shing KWAN, Singapore (SG); Ajit Shriman GAUNEKAR, Singapore (SG); SHIVANG, Singapore (SG)

(21) Appl. No.: 16/372,544

(22) Filed: Apr. 2, 2019

(51) Int. Cl. B08B 7/04; B08B 5/02; B08B 5/04

(52) U.S. Cl. CPC B08B 7/04; B08B 5/04; B08B 5/02

(57) ABSTRACT

A substrate cleaning apparatus for cleaning debris from a substrate has a first air jet nozzle defining a first air jet aperture configured to provide a first air jet, a second air jet nozzle defining a second air jet aperture configured to provide a second air jet, and a vacuum nozzle defining a vacuum aperture positioned between the first air jet nozzle and the second air jet nozzle. The vacuum aperture further comprises lobe apertures radially extending transversely to a first axis extending between the first air jet nozzle and the second air jet nozzle.

### FIELD OF THE INVENTION

The invention relates to air jet substrate cleaning apparatus for dislodging and capturing particles from a substrate.

### BACKGROUND

In a conventional particle removing system, a removing head is located above a substrate which has particles to be removed from the surface thereof. This removing head has an airstream outlet which directs air towards the substrate and a vacuum inlet.

However, some problems may be encountered when attempting to effectively remove particles, particularly when those particles are very small.

It would be beneficial to have an improved particle removal apparatus as compared to the prior art.

### SUMMARY OF THE INVENTION

It is thus an object of this invention to seek to provide an apparatus which overcomes at least some of the aforementioned problems of the prior art.

According to a first aspect of the present invention, there is provided a substrate cleaning apparatus for cleaning debris from a substrate, comprising:
a first air jet nozzle defining a first air jet aperture configured to provide a first air jet;
a second air jet nozzle defining a second air jet aperture configured to provide a second air jet; and
a vacuum nozzle defining a vacuum aperture positioned between the first air jet nozzle and the second air jet nozzle, the vacuum aperture further comprising lobe apertures radially extending transversely to an first axis extending between the first air jet nozzle and the second air jet nozzle.

The first aspect recognizes that a problem with cleaning substrates is that debris or particles dislodged from the substrate by air jets may not be fully removed and instead may simply land on another location on the substrate. Accordingly, an apparatus is provided. The apparatus may be a cleaning apparatus for removing debris or particles from a substrate. The apparatus may comprise a first nozzle or conduit which provides a first aperture or opening configured or located to deliver a first air jet. The apparatus may comprise a second nozzle or conduit which provides a second aperture or opening configured or located to deliver a second air jet. The first air jet aperture and the second air jet aperture may be configured direct the first air jet and the second air jet towards the substrate. The apparatus may comprise a vacuum nozzle or conduit which provides a vacuum aperture or opening. The vacuum aperture may be positioned or located between the air jet apertures. The air jet apertures may be aligned along an axis. The vacuum aperture may be located on that axis between the air jet apertures. The vacuum aperture may be configured to receive air jets reflected from the substrate. The vacuum aperture may have lobe apertures which may be located along an axis which extends transversely to the first axis. In this way, the lobe apertures provide an enlarged opening which helps to capture any particles or debris carried by the air jets reflected from the substrate, which helps remove particles within the air jets and reduces the likelihood of particles or debris being moved from one location on the substrate to another.

In one embodiment, the lobe apertures widen radially. Accordingly, the lobe apertures increase in area from a central position between the first and second air jet nozzles away from the vicinity of the air jet apertures.

In one embodiment, the vacuum aperture further comprises an opposing pair of the lobe apertures radially extending transversely to the first axis. Hence, the lobe apertures may be symmetric about the first axis.

In one embodiment, the vacuum aperture is defined by a central narrowed aperture having the opposing pair of lobe apertures extending therefrom. Hence, a narrower aperture than the opposing pair of lobe apertures, may be provided, which narrowed aperture is located centrally.

In one embodiment, the lobes comprise sector apertures. Accordingly, the lobes may each be shaped generally as a sector of a circle.

In one embodiment, a combined cross-sectional area of the first air jet aperture and the second air jet aperture is smaller than a cross-sectional area of the vacuum aperture. Hence, the area of the vacuum aperture may be greater than that of the air jet apertures.

In one embodiment, at least one of the first air jet nozzle, the second air jet nozzle and the vacuum nozzle define a lip shape to reduce direct flow of at least one of the first air jet and the second air jet into the vacuum aperture. The provision of the lip helps to prevent direct flow from the air jet apertures into the vacuum aperture.

In one embodiment, the first air jet nozzle and the second air jet nozzle each comprise a truncated cylinder.

In one embodiment, the first air jet aperture and the second air jet aperture are configured to generate a rotating airstream from the first air jet and the second air jet which rotates about an axis extending through a centre of the vacuum aperture. Generating a rotating airstream helps to provide for a stable airflow which can capture and remove particles or debris dislodged from the substrate surface.

In one embodiment, the first air jet aperture and the second air jet aperture are configured to direct the first air jet and the second air jet towards each other in opposing directions to generate the rotating airstream. Accordingly, the sheer created by the opposing air flows helps to generate the rotating airstream.

In one embodiment, the first air jet aperture and the second air jet aperture are configured to direct the first air jet and the second air jet towards the axis to generate the rotating airstream.

In one embodiment, the axis extends transversely from a surface of the substrate. Hence, the rotating airstream may rotate about an axis which upstands from the surface of the substrate.

In one embodiment, the axis extends from the substrate through a centre of the vacuum aperture. Accordingly, the rotating airstream may aligned to rotate around the centre of the vacuum aperture.

In one embodiment, the first air jet aperture and the second air jet aperture are configured to direct first air jet and the second air jet at an offset from the centre to generate the rotating airstream.

In one embodiment, the first air jet aperture and the second air jet aperture are configured to direct first air jet and the second air jet to be parallel and at an offset from the centre to generate the rotating airstream.

In one embodiment, the first air jet aperture and the second air jet aperture are configured to direct first air jet and the second air jet to flow as parallel secants on either side of the centre to generate the rotating airstream.

In one embodiment, the first air jet aperture and the second air jet aperture are configured to direct first air jet and the second air jet to flow with tangential components with respect to the vacuum aperture to generate the rotating airstream

In one embodiment, the vacuum aperture defines scoop portions shaped to capture at least a portion of the rotating airstream. Accordingly, the vacuum aperture may have projections or surfaces which are shaped or configured to interact with the rotating airstream and direct it into the vacuum aperture.

In one embodiment, the vacuum aperture defines radially extending lobes which provide the scoop portions.

In one embodiment, each scoop defines a leading edge which directs the portion of the rotating airstream into the vacuum aperture.

These and other features, aspects, and advantages will become better understood with regard to the description section, appended claims, and accompanying drawings.

### BRIEF DESCRIPTION OF THE DRAWINGS

Embodiments of the present invention will now be described, by way of example only, with reference to the accompanying drawings, in which:

FIG. 1 illustrates a bottom view of a substrate cleaning apparatus according to one embodiment;

FIG. 2 is a sectional view along the line S-S of FIG. 1;

FIG. 3 is an enlarged sectional view;

FIG. 4 is an enlarged bottom view;

FIG. 5 shows an isometric view of the vacuum aperture;

In the drawings, like parts are denoted by like reference numerals.

### DETAILED DESCRIPTION

Before discussing the embodiments in any more detail, first an overview will be provided. Embodiments provide an apparatus used for cleaning micron level particles or other debris from a substrate (such as an image sensor) using a non-contact method. The cleaning device contains a high pressure air outlet and vacuum inlet. The apparatus has a nozzle which has two or more apertures located to convey opposing air jets obliquely towards a surface of a substrate. The two inclined jets have velocity values in the ultrasonic range. The air jets converge and hit the substrate to dislodge any particles or debris present. After being removed using the high pressure air jets, these particles are captured. The apparatus has an elongate vacuum aperture located generally above the location where the opposing air jets converge. The vacuum aperture extends generally perpendicularly to the direction of flow of the air jets to capture or entrain reflected air jets flowing away from the surface of the substrate. The vacuum aperture widens away from the location where the opposing air jets converge. The shape of the vacuum aperture helps to capture and direct the air jets reflected from the surface of the substrate, together with any particles or debris. Also, the shape and positioning of the air jets and the vacuum aperture helps to prevent air flow from the air jets transiting directly into the vacuum aperture without first being reflected from the surface of the substrate. Although not essential, turbulence can be enhanced by offsetting the flow paths of the air jets in order to create a rotating vortex. In that embodiment, the vacuum apertures are provided with scoop sections which help to capture and direct the rotating effluent.

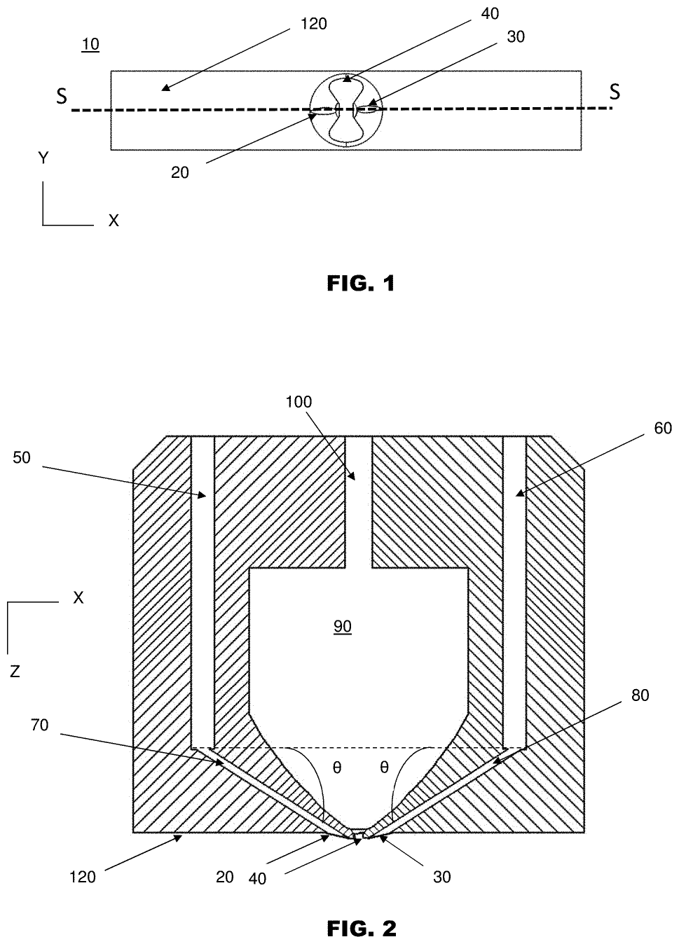

FIG. 1 illustrates a bottom view of a substrate cleaning apparatus 10, according to one embodiment. The substrate cleaning apparatus 10 has a first air jet aperture or outlet 20 and a second air jet aperture or outlet 30. The substrate cleaning apparatus 10 has a vacuum aperture or port 40 located between the air jet apertures 20, 30.

FIG. 2 is a sectional view along the line S-S of FIG. 1. As can be seen, a first air jet conduit 50 extends through the substrate cleaning apparatus 10 along a Z axis. Likewise, a second air jet conduit 60 extends through the substrate cleaning apparatus 10 along the Z axis. The first air jet conduit 50 fluidly couples with a first oblique air jet conduit 70, which extends from the first air jet conduit 50 at an angle θ to an X axis, which extends perpendicularly to the Z axis. Likewise, the second air jet conduit 60 fluidly couples with a second oblique air jet conduit 80 at the angle θ to the X axis. In this example, the angle θ is around 45°, but the angle may vary depending on requirements, such as the expected distance of the substrate from the substrate cleaning apparatus 10. Hence, the first oblique air jet conduit 70 and the second oblique air jet conduit 80 face each other and provide the air jet apertures 20, 30 proximate to and either side of the vacuum aperture 40. An air supply (not shown) is fluidly coupled with the first air jet conduit 50 and the second air jet conduit 60 to convey air flows out of the air jet apertures 20, 30.

The vacuum aperture 40 is coupled with a vacuum chamber 90 which is, in turn, fluidly coupled with a vacuum conduit 100. A vacuum pump (not shown) is fluidly coupled with the vacuum conduit 100 to convey air and any particulate material through the vacuum aperture 40.

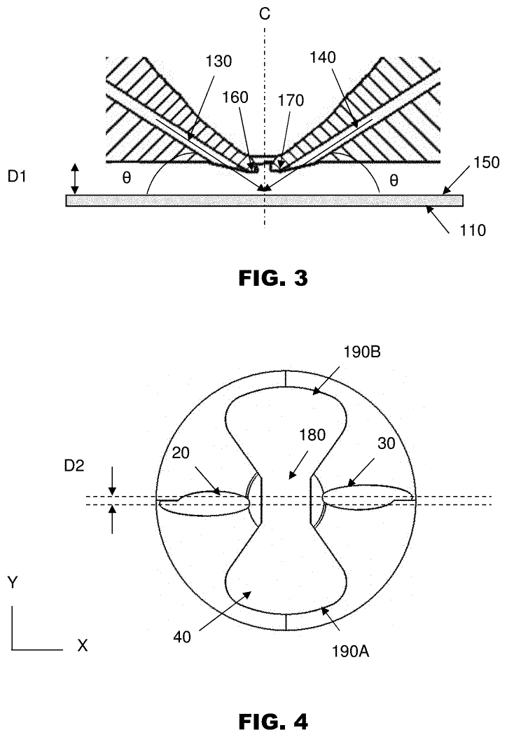

FIG. 3 is an enlarged sectional view showing the arrangement of the air jet apertures 20, 30 and the vacuum aperture 40 in relation to a substrate 110. As can be seen, the substrate 110 is positioned a distance D1 from a lower surface 120 of the substrate cleaning aperture 10 which defines the air jet apertures 20, 30 and the vacuum aperture 40. The angle θ and/or the distance D1 is selected such that the path of the air jets 130, 140 emitted from the air jet apertures 20, 30 intersect near a facing surface 150 of the substrate 110. Also, angle θ and/or the distance D1 is selected such that the air jets 130, 140 converge near a centreline C extending through the vacuum aperture 40 along the Z axis. The narrow air jets 130, 140 are both directed towards a centre C of the structure, and the fluid that is “bounced” or reflected off the surface 150 being cleaned is sucked in by a much wider vacuum port 40 that essentially surrounds the centre of the structure, ensuring that most of the resultant fluid is captured. The outlets 20, 30 are straight and aimed towards the middle of the apparatus 10. Once the outlet air hits the surface, it will reflect off the surface 150 and be sucked in by the relatively large suction hole provided by the vacuum aperture 40, which occupies a large portion of the lower surface 120.

This approach is more effective than existing arrangements where the surface areas covered by the vacuum suction ports is generally relatively large and may not be effective in removing micron-sized particles after dislodgement since very strong suction would be required to cater for the large area addressed by the suction device. If removal of the dust particles is not effective, they may just settle again on the facing surface 150. Moreover, some of the air from the air jet may in those existing arrangements be exhausted directly by the vacuum suction device from the air jet before impacting the surface to be cleaned, which reduces the effectiveness of the air jet. In this embodiment, the nozzle sizes are relatively small and the air jet apertures 20, 30 and vacuum suction aperture 40 are configured so that the cleaning of surfaces is more localised. In particular, the vacuum suction port 40 is located at a middle section of the nozzle between the air jets 130, 140. The winged design of the vacuum aperture 40 ensures that the air jets are not being sucked into the vacuum port directly before the air jets impact on the contaminant particles, and the dislodged particles can be captured with greater certainty by the vacuum aperture 40 at the centre of the nozzle.

As can be seen in FIG. 3, the air jet apertures 20, 30 are set back radially from the vacuum aperture 40 and are provided with projections 160, 170 which shield the vacuum aperture 40 from the direct flow out of the air jet apertures 20, 30. This helps to prevent any direct flow from the air jet apertures 20, 30 into the vacuum aperture 40. Instead, the vacuum aperture 40 receives air flow reflected from the facing surface 150.

FIG. 4 is an enlarged bottom view of the substrate cleaning apparatus 10. As can be seen, the air jet apertures 20, 30 are generally aligned along the X axis. The vacuum aperture 40 is located between the air jet apertures 20, 30. The vacuum aperture 40 extends along a Y axis, which is perpendicular to the X axis. The vacuum aperture 40 has a central section 180, located closest to the air jet apertures 20, 30 and a pair of wing-shaped lobes 190A, 190B which extend radially from the central aperture 180 along the Y axis. The lobes 190A, 190B widen radially from the central section 180 to define generally sector-shaped apertures. Thus, the vacuum aperture 40 resembles a generally figure-eight or hour-glass shaped aperture. This shape helps to prevent air from the air jet apertures 20, 30 flowing directly into the central portion 180 and enhances the capture of the air jets reflected from the facing surface 150.

In particular, the shape of the vacuum aperture 40 enhances performance because the central portion 180 (below which the air jets 160, 170 are directed) is narrowed so that the air jets 160, 170 are not sucked in directly, whereas the broader sections 190A, 190B are more capable of indirectly capturing the reflected air jets. This is better than existing designs having a single central circular opening, where the suction force sucking the air jets in directly is exactly the same as the suction force sucking the reflected air jets indirectly (e.g. such that a larger hole would only suck in more of the air jets directly, whereas a smaller hole sucks in less of the air jets directly but would be less efficient in capturing reflected air jets).

As can be seen in FIG. 4, in this example, the air jet apertures 20, 30 are not completely axially aligned along the X axis. Instead, they are slightly offset by a distance D2. This causes the air jets 130, 140 to generate a rotating vortex which rotates about a central axis C extending through the vacuum aperture 40. Hence, the axes of the pair of air jets are slightly offset from each other in order to produce greater turbulence in the combination of air jets (like a cyclone) to generate a greater force to dislodge particles from the surface and increase cleaning efficiency. It will be appreciated that a similar effect can be achieved by directing the air jets 130, 140 in a direction with a tangential component, particularly in embodiments where more than two air jets 130, 140 are provided. The apparatus 10 is relatively small to pick up micron-sized particles, so the air turbulence caused by the offset is accordingly also on quite a small scale.

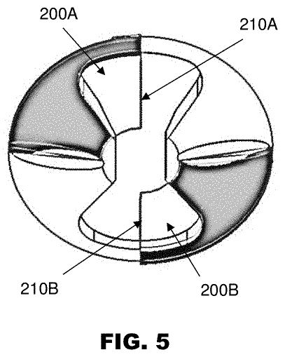

FIG. 5 shows an isometric view of the vacuum aperture 40 which has scoop portions 200A, 200B shaped to capture the rotating vortex and also help prevent direct flow of the air jets 130, 140 into the vacuum aperture 40. The scoop portions 200A, 200B each has a leading edge 210A, 210B which contacts and entrains or directs the airflow from the rotating vortex over the face of the scoop portions 200A, 200B and into the vacuum chamber 90. Again, this helps to enhance the flow of the reflected air jets together with captured particles or debris away from the facing surface 150 and into the vacuum chamber 90.

Hence, it can be seen that embodiments provide an arrangement where the controlled air jet and vacuum effect is such that the air jet first dislodges the particle from the substrate followed by suction of the particle in the vacuum chamber through the vacuum port. The convergent jets when using an offset induces higher turbulence and the vacuum in the centre creates additional vorticity environment which aids in breakage of adhesive bonds with the substrate surface. The design of the nozzle tip is such that the air-jet is protected from getting sucked in the vacuum port before impacting on the contaminant particle on the substrate. The dislodged contaminant particle is captured with improved certainty by the vacuum port and thus prevented from contaminating other parts of the substrate. The axes of the nozzles can have a miniscule offset whereby turbulence and additional vorticity domains may be created at the substrate surface, which enhance the breakage of adhesive bonds of contaminant particles with the substrate surface.

Although the present invention has been described in considerable detail with reference to certain embodiments, other embodiments are possible.

Therefore, the spirit and scope of the appended claims should not be limited to the description of the embodiments contained herein.

1. A substrate cleaning apparatus for cleaning debris from a substrate, comprising:
a first air jet nozzle defining a first air jet aperture configured to provide a first air jet;
a second air jet nozzle defining a second air jet aperture configured to provide a second air jet; and
a vacuum nozzle defining a vacuum aperture positioned between said first air jet nozzle and said second air jet nozzle, said vacuum aperture further comprising lobe apertures radially extending transversely to a first axis extending between said first air jet nozzle and said second air jet nozzle.

2. The substrate cleaning apparatus of claim 1, wherein said lobe apertures widen radially from a central position between the first and second air jet nozzles.

3. The substrate cleaning apparatus of claim 1, wherein said vacuum aperture further comprises an opposing pair of said lobe apertures radially extending transversely to said first axis.

4. The substrate cleaning apparatus of claim 3, wherein said vacuum aperture is defined by a central narrowed aperture having said opposing pair of lobe apertures extending therefrom.

5. The substrate cleaning apparatus of claim 1, wherein said lobes comprise sector apertures.

6. The substrate cleaning apparatus of claim 1, wherein a combined cross-sectional area of said first air jet aperture and said second air jet aperture is smaller than a cross-sectional area of said vacuum aperture.

7. The substrate cleaning apparatus of claim 1, wherein at least one of said first air jet nozzle, said second air jet nozzle and said vacuum nozzle define a lip shape to reduce direct flow of at least one of said first air jet and said second air jet into said vacuum aperture.

8. The substrate cleaning apparatus of claim 1, wherein said first air jet nozzle and said second air jet nozzle each comprise a truncated cylinder.

9. The substrate cleaning apparatus of claim 1, wherein said first air jet aperture and said second air jet aperture are configured to generate a rotating airstream from said first air jet and said second air jet which rotates about an axis extending through a centre of said vacuum aperture.

10. The substrate cleaning apparatus of claim 9, wherein said first air jet aperture and said second air jet aperture are configured to direct said first air jet and said second air jet towards each other in opposing directions to generate said rotating airstream.

11. The substrate cleaning apparatus of claim 9, wherein said first air jet aperture and said second air jet aperture are configured to direct said first air jet and said second air jet towards said axis to generate said rotating airstream.

12. The substrate cleaning apparatus of claim 9, wherein said axis extends transversely from a surface of said substrate.

13. The substrate cleaning apparatus of claim 9, wherein said axis extends from said substrate through a centre of said vacuum aperture.

14. The substrate cleaning apparatus of claim 13, wherein said first air jet aperture and said second air jet aperture are configured to direct first air jet and said second air jet at an offset from said centre to generate said rotating airstream.

15. The substrate cleaning apparatus of claim 13, wherein said first air jet aperture and said second air jet aperture are configured to direct first air jet and said second air jet to be parallel and at an offset from said centre to generate said rotating airstream.

16. The substrate cleaning apparatus of claim 13, wherein said first air jet aperture and said second air jet aperture are configured to direct first air jet and said second air jet to flow as parallel secants on either side of said centre to generate said rotating airstream.

17. The substrate cleaning apparatus of claim 9, wherein said first air jet aperture and said second air jet aperture are configured to direct first air jet and said second air jet to flow with tangential components with respect to said vacuum aperture to generate said rotating airstream.

18. The substrate cleaning apparatus of claim 9, wherein said vacuum aperture defines scoop portions shaped to capture at least a portion of said rotating airstream.

19. The substrate cleaning apparatus of claim 18, wherein said vacuum aperture defines radially extending lobes which provide said scoop portions.

20. The substrate cleaning apparatus of claim 18, wherein each scoop portion defines a leading edge which directs said portion of said rotating airstream into said vacuum aperture.
